(19) United States
(12) Patent Application Publication
(10) Pub. No.: US 2022/0305700 A1
(43) Pub. Date: Sep. 29, 2022

(54) METHOD FOR MANUFACTURING A TIMEPIECE COMPONENT

(71) Applicant: ROLEX SA, Geneva (CH)

(72) Inventors: Florian Calame, Epalinges (CH); Benjamin Celant, Geneva (CH)

(73) Assignee: ROLEX SA, Geneva (CH)

(21) Appl. No.: 17/683,722

(22) Filed: Mar. 1, 2022

(30) Foreign Application Priority Data
Mar. 3, 2021 (EP) 21160550.6

(51) Int. Cl. B29C 41/12; G04B 45/00; B29C 41/38; A44C 5/00

(52) U.S. Cl. CPC B29C 41/12; G04B 45/0076; B29C 41/38; A44C 5/0069; B29L 2029/00

(57) ABSTRACT

A method for manufacturing a structured insert (10) for a mold for manufacturing a timepiece or jewelry component, for example a bracelet strand,
including: —providing (E1) a template element (50) comprising a structured surface (51) with a pattern to be reproduced on a surface of a timepiece
component; —covering (E2) the structured surface (51) of the template element (50) with a molding resin capable of reproducing a negative pattern of the pattern of the structured surface, and leaving the molding resin to solidify in order to obtain a structured
insert (10); —separating (E3) the structured insert (10) from the template element (50), the structured insert (10) comprising a surface comprising the negative
pattern; —optionally, cutting the structured insert (10) to the format corresponding to at least part of the timepiece component to be manufactured.

This application claims priority of European patent application No. EP21160550.6 filed Mar. 3, 2021, the content of which is hereby incorporated by reference herein in its entirety.

The present invention relates to a method for manufacturing a structured insert for a mold for manufacturing a timepiece or jewelry component. It also relates to a method for manufacturing a timepiece or jewelry component that uses such a structured insert. It also relates to a timepiece component as such, in particular a bracelet strand, particularly an elastomer bracelet strand, obtained using such a method.

It is routine practice in horology for a bracelet strand to be formed from an elastomer material. It is desirable to be able to form a surface of such a bracelet strand with a selected, particularly attractive appearance.

In order to achieve such a result, manufacturing a bracelet strand by means of a steel metal mold is known, the geometry of which directly forms a predefined texture on the bracelet strand. Such an approach has the first disadvantage of a lack of versatility, since changing the appearance of the bracelet requires changing the mold. Therefore, such a solution is not suitable for manufacturing small batches. It also has the second disadvantage of not allowing any texture to be produced, or at least with insufficient precision. Finally, producing a textured surface on the mold is often complex and delicate, and such a surface cannot be repaired in the event of alteration, which is a third disadvantage of this solution.

Another additional approach involves modifying the appearance of the surface of the bracelet strand after it has left a mold, using one or more additional finishing steps, for example, using a calendering step. Such an approach makes the method even more complex by adding one or more additional steps. Furthermore, it does not allow all types of textures to be formed.

Thus, the aim of the present invention is to improve the known methods for manufacturing a timepiece or jewelry component, and in particular to achieve all or some of the following aims.

The first aim of the invention is to be able to manufacture a timepiece or jewelry component with a defined technical functionality, in particular, a hydrophilic or hydrophobic character, and/or with an attractive aesthetic appearance, in particular having a structured surface with a selected pattern.

The second aim of the invention is to be able to manufacture a timepiece or jewelry component comprising a structured surface made of elastomer.

The third aim of the invention is to be able to manufacture a timepiece or jewelry component comprising a structured surface with a complex shape.

The fourth aim of the invention is to be able to manufacture a timepiece or jewelry component comprising a structured surface suitable for small manufacturing batches, in particular for the purpose of being able to easily change the pattern of the structured surface of the timepiece component to be manufactured.

To this end, the invention is based on a method for manufacturing a structured insert for a mold for manufacturing a timepiece or jewelry component, in particular for manufacturing a bracelet strand, characterized in that it comprises the following steps:
providing a template element (or a model element) comprising a structured surface with a pattern to be reproduced on a surface of a timepiece component;
covering said structured surface of the template element with a molding resin capable of reproducing a negative pattern of said pattern of the structured surface, and leaving the molding resin to solidify in order to obtain a structured insert;
separating the structured insert from the template element, said structured insert comprising a surface comprising said negative pattern;
optionally, cutting the structured insert to the format corresponding to at least part of the timepiece component to be manufactured.

The invention also relates to a timepiece component made of elastomer material, in particular a bracelet strand, characterized in that it comprises a one piece and optionally integrally formed part, comprising a structured surface that comprises all or some of the following features:
at least one relief, the height of which, measured in the direction perpendicular to said structured surface, ranges between 1 nm and 2 mm, or even between 1 nm and 500 μm, or even between 1 nm and 10 μm, or even between 1 nm and 10 nm; and/or
a plurality of intersecting reliefs; and/or
at least one cavity, the opening of which is narrower than its largest width or which comprises a lower section parallel to the structured surface with a larger area than another parallel section positioned above the lower section.

The invention also relates to an assembly comprising a template element and such a timepiece component, characterized in that the timepiece component comprises a structured surface that reproduces a structured surface of the template element with a resolution that is less than or equal to 1 μm, or even less than or equal to 100 nm, or even less than or equal to 10 nm, or even less than or equal to 1 nm.

The invention is more specifically defined by the claims.

These aims, features and advantages of the present invention will be set forth in detail in the following description of particular embodiments, which are provided by way of a non-limiting example with reference to the accompanying figures, in which:

FIG. 1 schematically shows the steps of a method for manufacturing a structured insert according to one embodiment of the invention;

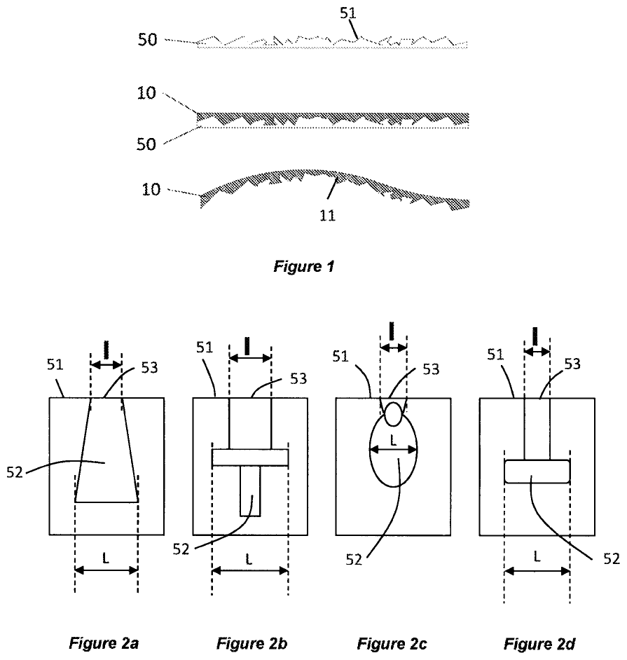

FIGS. 2a to 2d show section views of cavities formed in the surface of a template element according to embodiments of the method of the invention;

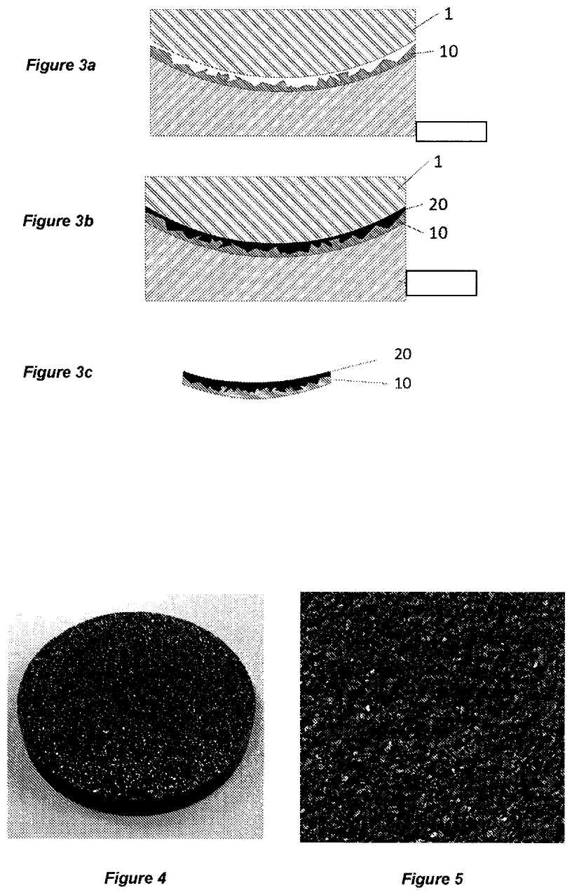

FIGS. 3a to 3c schematically show the steps of a method for manufacturing a timepiece component according to one embodiment of the invention;

FIG. 4 shows a template element used by the method according to the embodiment of the invention;

FIG. 5 shows an exploded view of the structured surface of the template element of FIG. 4;

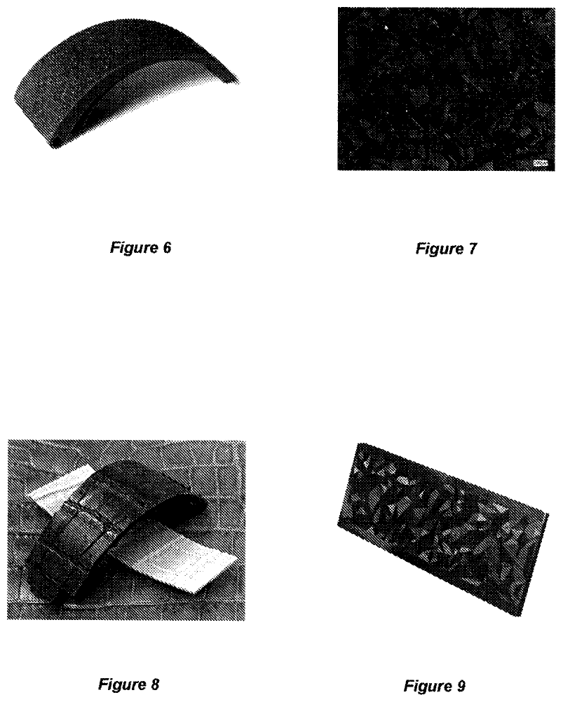

FIG. 6 shows a top perspective view of a bracelet strand manufactured according to the embodiment of the invention;

FIG. 7 shows an exploded view of the structured surface of the bracelet strand of FIG. 6;

FIG. 8 shows a template element according to another example and a corresponding bracelet strand resulting from the manufacturing method of the invention;

FIG. 9 shows a template element according to yet another embodiment of the manufacturing method of the invention.

The invention achieves the intended aims by means of the intermediate manufacture of a structured insert, which is intended to be inserted into a mold for manufacturing a timepiece or jewelry component in order to form a structured surface of the timepiece component that is manufactured in such a mold.

An embodiment of the invention will now be described in the context of manufacturing an elastomer bracelet. Of course, it can be used for manufacturing another timepiece or jewelry component from elastomer.

The method for manufacturing a timepiece component comprises a first phase of manufacturing a structured insert for a mold for manufacturing a timepiece component, schematically shown in FIG. 1.

The method comprises a first step E1 involving providing a template element 50 comprising a structured surface 51 with a pattern to be reproduced. The pattern of the structured surface of this template element is called “master pattern”: it is an existing pattern that is to be reproduced in an identical manner, with a very high degree of precision, on a surface of a bracelet strand. The template element also can be called “master”.

A structured surface is understood to be a surface that has positive and/or negative reliefs, i.e. that project or are recessed relative to the surface. These reliefs form a master pattern of the structured surface. Furthermore, this structured surface may or may not be flat, for example, curved. As will become apparent from the following description, the method according to the invention advantageously allows a wide variety of master patterns to be reproduced, including complex patterns and/or patterns involving very small dimensions, in particular micrometric or even nanometric dimensions. Naturally, the invention does not relate to the master pattern as such, which can be any pattern.

By way of an example, the master pattern can be a natural pattern, such as that present on the surface of an animal skin, a leather, an alligator skin, bark, a leaf, microcrystals, in particular silicon carbide crystals or ruthenium crystals, etc.

Alternatively, it can be non-natural, artificial, and produced on a substrate, which is natural or non-natural, using any known technique, such as traditional machining, laser etching, etc. For example, it can be formed by a metal textured by abrasion, in particular by forming a sunray or any other form of satin finishing, by traditional etching, by laser or by electrochemistry, or by a wafer with electroformed decorations obtained by depositing a metal into the cavities of a photopolymerized photosensitive resin, or by a surface of a silicon wafer, or by a fiber weave, etc. More generally, the master pattern, in the case whereby it is non-natural or artificial, can be obtained using any known technique. The master pattern can be manufactured on a substrate, with the master pattern and the substrate forming the template element. Alternatively, the master pattern can be obtained when manufacturing the template element. For example, the template element and/or the master pattern can be obtained by additive manufacturing or 3D printing. Such a method for manufacturing the template element and/or the master pattern has the advantage of creating varied and complex designs quickly and in a very versatile manner.

As mentioned above, the master pattern can be complex. By way of an example, it can comprise hollow portions forming complex shaped cavities, in particular having an opening that is narrower than its width or more broadly comprising a lower section parallel to the structured surface with a larger surface area than another parallel section placed above the lower section, i.e. having a shape such that it has a bottleneck when the cavity is demolded.

FIGS. 2a to 2d illustrate examples of complex cavities shown as a cross-section, in a plane perpendicular to the structured surface 51 of a template element, which structured surface 51 thus comprises at least one such complex cavity 52, or even many identical or different complex cavities. Such a complex cavity 52 comprises an opening 53 opening onto the structured surface 51, then extending into the depth of the template element. This complex cavity 52 comprises at least one section, as shown in these figures, such that the largest width L of this section in a plane parallel to the structured surface 51 is greater than the width I of the opening 53. More generally, a complex cavity can comprise a first section parallel to the structured surface 51 of the template element with a larger area than a second superimposed parallel section positioned above this first parallel section, i.e. closer to the opening 53. The specific feature of these cavity shapes originates from the fact that they induce complexity in a demolding step of an injection method, which comprises injecting a material into such a cavity, since the cavity comprises a narrow section forming a bottleneck when removing the solidified injected material.

The complexity can also originate from a very large number of projecting and/or recessed reliefs, which can be juxtaposed or intersecting.

Finally, the complexity can originate from the resolution of the master pattern, which can involve very small dimensions. By way of an example, the structured surface 51 of the template element can comprise at least one relief, the height H of which, measured in the direction perpendicular to the structured surface 51, ranges between 1 nm and 2 mm, or even between 1 nm and 500 μm, or even between 1 nm and 10 μm, or even between 1 nm and 10 nm. Thus, the structured surface 51 of the template element can comprise at least one millimetric relief or at least one micrometric relief or at least one nanometric relief, or a combination of millimetric reliefs and/or of micrometric reliefs and/or of nanometric reliefs.

As the invention allows complex patterns to be reproduced, it has the advantage of being compatible with the reproduction of a wide variety of textures. Of course, it is still compatible with any texture other than the examples shown, and can also be implemented to reproduce simple textures.

The method then comprises a second step E2 involving covering said structured surface of the template element 50 with a molding resin, capable of reproducing a negative pattern of said master pattern of the template element, following the solidification of the molding resin, in order to obtain a structured insert 10.

Advantageously, the molding resin has a viscosity before solidification at ambient temperature and pressure ranging between 0.5 and 70′000 Pa·s⁻¹, or even between 0.5 and 30′000 Pa·s⁻¹, or even between 0.5 and 1′000 Pa·s⁻¹. Such a selection promotes its infiltration into the cavities, including the complex cavities, of the structured surface of the template element 50. It thus penetrates the smallest corners of the structured surface of the template element 50, in order to very precisely reproduce the shape of this structured surface. As it solidifies, all the details of the surface on which the molding resin has been applied are reproduced very precisely. The precision of the reproduction can be of the order of a micrometer or even of a nanometer.

By way of an example, the molding resin comprises polyurethane, latex, acrylic resin, fluoroelastomer, such as FKM, PDMS (PolyDimethylSiloxane), an epoxy resin, or two-component silicone, in particular two-component addition-vulcanizing silicone, in particular from the family of vinyl-polydimethyl-siloxanes, or in particular comprising vinyl, silicic acid and aggregating materials. The molding resin can also comprise one or more additives selected from among an additive, an aggregating material, and a colorant.

Alternatively, a more viscous resin or even a paste or solid material, such as a raw fluorocarbon rubber (FKM), also can be used. In such a case, a high pressure advantageously will be applied to this resin to allow it to infiltrate all the reliefs, in particular the cavities, of the template element. A compromise will be sought in order to define the applied pressure in order to precisely reproduce the master pattern without damaging the template element.

After solidification, the molding resin forms a resin structured insert 10. Preferably, this structured insert 10 is flexible. In particular, its flexibility is adapted so that it can be demolded from the template element 50, in particular in the case whereby the template element comprises a pattern with complex cavities. Advantageously, the molding resin exhibits little or no shrinkage, in order to faithfully reproduce and maintain the features of the pattern to be reproduced. For example, the shrinkage is less than or equal to 2 ‰, or even less than or equal to 1 ‰. The molding resin is selected so as to achieve, once solidified, flexibility that is compatible with the extraction stress, computed using the following formula:

$$1 - [ \frac{Minimum dimension of the extraction orifice}{Maximum internal dimension} ] \vert = Extraction Stress ( as \% )$$

The higher the extraction stress, the more flexible and elastic the molding resin will need to be in order for the resulting structured insert to be removed without degradation, while retaining the integrity of the texture to be replicated. In other words, the molding resin is selected so as to form a structured insert 10 that can be separated from the template element without damaging the template element or the structured insert.

Preferably, the solidification of the molding resin, on completion of which the impression of the master pattern is considered to be made, corresponds to its polymerization. It comprises two steps: setting of the resin, after which the resin is dry to the touch, then hardening of the resin, after which the final mechanical properties of the resin are achieved.

The polymerization kinetics of the molding resin for setting the impression are generally fast. In particular, the polymerization time at ambient temperature can range between 1 and 30 minutes, preferably between 1 and 15 minutes. By way of an example, in the particular case of the use of two-component silicone, the setting time at ambient temperature (20° C.) ranges between 15 and 90 seconds. The hardening time ranges between 1 and 10 minutes. Thus, selecting this silicone as a molding resin is particularly advantageous: its solidification time is short and this silicone can be implemented with a very simple installation.

The method then comprises a third step E3 involving separating the structured insert 10 from the template element 50, with this structured insert 10 comprising a structured surface 11 reproducing the negative master pattern.

As mentioned above, the solidified molding resin retains a level of flexibility that allows it to be easily demolded from the template element 50, without damaging the pattern of the structured surface 11. The structured insert 10 thus comprises a structured surface 11, which corresponds to the identical reproduction of the structured surface 51 of the template element 50 as a negative.

Beforehand, the template element is preferably cleaned before applying the molding resin in order to have a reception surface, comprising the structured surface to be reproduced, that is perfectly clean when the molding resin is applied. Optionally, this surface also can be coated with a release agent. Thus, the separation of the structured insert 10 from the template element 50 is facilitated, as the structured insert can be easily detached, without adhering to the template element. The molding resin therefore does not leave any residue on the surfaces of the template element, and retains an intact, undamaged structured surface, perfectly reproducing the structured surface of the template element.

Advantageously, the structured insert is compression resistant, while remaining flexible enough, which results in hardness ranging between 20 and 90 Shore A, or even between 20 and 40 Shore A or between 50 and 70 Shore A or between 80 and 90 Shore A. As specified above, this resistance, coupled with the flexibility of the insert, is suitable for the template element that is used.

In addition, the structured insert 10 that is obtained is flexible enough to be able to conform to the optionally non-planar shape of the mold surface on which it is intended to be positioned, as will be described hereafter. To this end, the apparent modulus of the structured insert 10 for 100% deformation is advantageously less than 300 MPa, or even less than 50 MPa, or even less than 10 MPa. Moreover, the nick-free tear resistance of the structured insert 10 according to standard ISO 34-1 B(a) is preferably greater than or equal to 5, or even greater than 10.

According to an advantageous embodiment, after this step of demolding the molding resin, the structured insert 10 is obtained directly. Optionally, the method comprises an additional step of cutting the molding resin separated from the template element in order to form the structured insert in its final format.

Furthermore, the method can comprise an optional additional step of depositing a coating of a release agent onto the structured insert 10, in particular by coating, by chemical vapor deposition (CVD) or by physical vapor deposition (PVD), by atomic layer deposition (ALD), by sol-gel deposition, or by self-assembled monolayer (SAM) deposition, or by depositing a fluorinated coating onto the structured insert, for example, made from a material from among polytetrafluoroethylene (PTFE), fluorinated ethylene propylene (FEP), or perfluoroalkoxy (PFA).

The method for manufacturing a timepiece component then comprises a second phase of manufacturing a timepiece component as such, shown in FIGS. 3a to 3c, which uses the structured insert 10 manufactured by the method for manufacturing a structured insert described above, which therefore forms the first phase of the method for manufacturing a timepiece component.

This method comprises a fourth step E4 involving positioning the structured insert 10 in a mold 1 for manufacturing a timepiece component, in particular a metal mold, for example, made of steel, as shown in FIG. 3a. Advantageously, this positioning simply involves insertion into a housing provided in the mold to this end, in a manner that is tight enough to cause the structured insert 10 to be held in place. Therefore, said insert is advantageously held in place in the mold without gluing or fixing. This mold housing is a cavity, the shape and thickness of which correspond to those of the structured insert.

The structured insert 10 can assume any shape and can occupy all or part of the surface of the mold. Moreover, it is flexible enough to perfectly conform to the shape of the housing provided to receive it, without leaving any gaps. Its material also means that it does not adhere to the mold. It thus can be easily removed from the mold, without having to add a release agent to the surface of the mold.

Naturally, according to an advantageous embodiment, the structured insert 10 can be manufactured in the first phase as a shape at rest (corresponding to that of the template element), which corresponds to that of the mold housing, so that it will be perfectly matched to this housing with no (or little) need to deform it.

The method then comprises a step E5 involving filling the manufacturing mold 1 including the structured insert 10 with a component material, as shown in FIG. 3b, including filling the negative pattern of the structured surface of the structured insert 10, then leaving the component material to solidify in order to obtain a blank 20 of the timepiece component comprising a structured surface comprising the identical reproduction of the master pattern of the template element.

Advantageously, the component material is an elastomer or is based on an elastomer material, i.e. comprising at least 50% by weight of elastomer. In particular, the elastomer material can be a fluoroelastomer (FKM, FFKM or FEPM), or a natural (NR) or synthetic (SBR, HNBR, EPDM) rubber, or a vinyl methylsilicone (VMQ) or a fluorosilicone (FVMQ). Alternatively, the component material is a thermoplastic or thermoset polymer, provided that the geometry of the structure allows the insert to be separated from the component without degrading the component. The selection of the component material is such that it is adapted to a specific more or less complex shape of the timepiece component to be manufactured, with the most complex shapes requiring the use of a component material with the most effective mechanical properties.

Thus, the timepiece component is advantageously flexible. Moreover, it can assume a non-planar shape at rest, resulting from the shape of the manufacturing mold. This shape is advantageously curved or arched, in particular concave or convex. Thus, the timepiece component is advantageously curved or arched, in particular concave or convex. The timepiece component can be rigid at rest, i.e. retain a predefined shape at rest, which advantageously can be modified by resilient deformation, particularly in the case of a bracelet, due to the flexible material that is used.

It should be noted that the molding resin of the structured insert is naturally selected in order to be compatible with the conditions for filling the mold 1 with the component material. In particular, the structured insert withstands the vulcanization conditions of the elastomer forming the timepiece component. To this end, it withstands temperatures of 160° C., or even up to 180° C., or even up to 250° C., for at least 15 minutes, and preferably for several hours. At these temperatures, the structured insert can also withstand pressures ranging between 80 bar and 150 bar, or even between 80 bar and 90 bar, without deformation. In addition, the structured insert advantageously withstands, for example, several elastomer vulcanization cycles of 5 to 15 minutes each.

The step E5 involving filling the manufacturing mold therefore advantageously comprises casting or injecting the component material, and allows a timepiece component to be formed that comprises a structured surface as a single piece.

The method then comprises a step E6 involving removing the blank 20 of the timepiece component from the mold.

Advantageously, in this removal step, the structured insert 10 remains secured to said blank 20, as they are interleaved at the structured surface, and due to the fact that the structured insert does not catch on the manufacturing mold, as shown in FIG. 3c. In this case, the structured insert 10 fulfils a second function of protecting the structured surface of the blank 20 of the timepiece component. This blank 20 indeed can undergo one or more further optional steps E7 involving finishing the component, such as, for example, deburring, sandblasting, marking, and/or decorating, etc., during which its structured surface remains perfectly intact by virtue of the protection of the structured insert 10. The method then comprises a step E8 involving separating the blank 20 of the timepiece component from the structured insert 10 in order to obtain the timepiece component.

Alternatively, the structured insert 10 can be separated from the blank 20 during the step E6 involving removing the blank 20 from the mold 1. This structured insert 10 can be reused within the mold to manufacture a new blank and another identical timepiece component.

The invention thus achieves the intended aims and more generally has the following advantages:
the manufacturing method is simple to implement and inexpensive; for example, a complex and otherwise not very durable texture does not need to be formed on a surface of a steel mold;
it enables a timepiece component to be obtained comprising a highly accurate replica of a pattern of a template element;
the method is compatible with the manufacture of small batches, since a structured insert is easy to manufacture, and since structured inserts with different patterns can be introduced into the same manufacturing mold.

The invention also relates to a structured insert for a mold for manufacturing a timepiece component, characterized in that it is made of resin and comprises a structured surface comprising a negative pattern of a pattern to be reproduced on a timepiece component.

Such a structured insert can be characterized in that said negative pattern comprises all or some of the following features:
at least one raised relief, measured in the direction perpendicular to said structured surface of the template element, ranging between 1 nm and 2 mm, or between 1 nm and 500 μm, or even between 1 nm and 10 μm, or even between 1 nm and 10 nm; and/or
a plurality of intersecting reliefs; and/or
at least one cavity, the opening of which is narrower than its width or which comprises a lower section with a larger area than another section positioned above the lower section.

This structured insert can be flexible, with an apparent modulus for 100% deformation that is less than or equal to 300 MPa, or even less than or equal to 50 MPa, or even less than or equal to 10 MPa.

It can exhibit hardness ranging between 20 and 90 Shore A, or even between 20 and 40 Shore A or between 50 and 70 Shore A or between 80 and 90 Shore A. Its nick-free tear resistance can be greater than or equal to 5, or even greater than or equal to 10.

It can withstand a temperature of 160° C., or even a temperature of 180° C., or even a temperature of 250° C., for at least 15 minutes, or even at least one or two hours. It can withstand a maximum pressure ranging between 80 bar and 150 bar at these temperatures, without deformation.

The structured insert can be single use or can be used to manufacture a small number of timepiece components, for example, up to 50 timepiece components.

The invention also relates to a timepiece or jewelry component as such obtained using the method according to the invention. As mentioned, such a timepiece component can be a bracelet. As an alternative embodiment, it can be any external component of a watch bracelet, such as a watch bezel or a middle.

Such a timepiece component therefore has a structured surface, defining a pattern that can be complex. This pattern can comprise, for example, at least one cavity, the opening of which is narrower than the width or which comprises a lower section with an area that is larger than another section placed above the lower section. It can comprise at least one relief, the height of which, measured in the direction perpendicular to said structured surface, ranges between 1 nm and 2 mm, or even between 1 nm and 500 μm, or even between 1 nm and 10 μm, or even between 1 nm and 10 nm. The timepiece component can be entirely or partly integrally formed, or even a single piece. The timepiece component can comprise one or more inserts, such as a reinforcing strip, as described in document EP2783592A1. The structured surface can comprise a plurality of intersecting reliefs.

The invention also relates to a watch bracelet comprising at least one timepiece component as described above.

The invention also relates to an assembly comprising a template element and a timepiece component, which comprises a structured surface that reproduces a structured surface of the template element with resolution that is less than or equal to 1 μm, or even less than or equal to 100 nm, or even less than or equal to 10 nm, or even less than or equal to 1 nm.

Various examples of manufacturing bracelets using the method according to the invention will be presented in order to illustrate the results.

According to a first example, the selected “master” pattern is formed by silicon carbide crystals, for example, formed from an upper surface of a silicon carbide disk, as shown in FIG. 4, which thus represents the selected template element. FIG. 5 shows an exploded view of this upper surface, allowing its texture to be shown. The considered structured surface extends in a plane. It is cleaned and degreased, then dried. A two-component silicone containing vinyl, silicic acid and aggregating materials is used to produce the structured insert. This material can be that known under its trade name of Plastiform™ F50 or Plastiform™ F85. The two components of the silicone are mixed inside a dosing gun, which allows the mixture to be deposited onto part of the structured surface of the template element, i.e. the upper surface of the silicon carbide disk. The resin is deposited onto this surface as a 0.5 mm thick layer. Once the two components are mixed, the silicone polymerizes at ambient temperature in two minutes. It is very fluid but feels dry to the touch very quickly following application. Its setting time is approximately 20 seconds. When the silicone is hardened, it is detached from the disk and cut to the dimensions of the central part of a watch bracelet in order to form a flexible structured insert. More specifically, the structured insert does not comprise a fixed shape at rest, it is flexible enough to conform to the shape of a support on which it is positioned. Advantageously, the structured insert has a maximum thickness ranging between 0.2 mm and 2 mm, or even between 0.2 mm and 1 mm. The insert is then placed in a bracelet strand injection mold. It perfectly conforms to the curved housing produced in the mold to receive it.

An elastomer material, preferably a fluoroelastomer (FKM), is then injected into the mold, at a pressure of 80 bar, at a temperature of 80° C. Vulcanization at 180° C. is then carried out in 15 minutes, then the mold is cooled, opened and the blank obtained by this injection is removed. The structured insert is retained on the structured surface of this bracelet strand blank, in order to act as protection for the subsequent manufacturing steps, in particular deburring or sandblasting.

On completion of this method, a bracelet strand for a watch bracelet is formed, comprising a structured surface faithfully reproducing the master patterns of the upper surface of the silicon carbide disk. It should be noted that such patterns cannot be obtained by means of conventional machining of the mold. FIG. 6 shows a perspective top view of the manufactured bracelet strand, the upper surface of which is structured, identically reproducing the pattern of the upper surface of part of the silicon carbide disk. FIG. 7 shows an exploded view of this structured surface of the bracelet, allowing its pattern to be clearly distinguished.

According to a second embodiment of the invention, the template element is an alligator skin, which allows a bracelet strand to be obtained that is made of elastomer material, as shown in FIG. 8.

According to a third embodiment of the invention, the template element is a metal plate with an engraved surface, shown in FIG. 9.

It should be noted that patterns with a depth of up to 500 μm cannot be obtained from a mold machined using conventional techniques. Indeed, machining in order to obtain a very fine pattern on a surface of a timepiece component is too complex to apply to a curved surface within a mold.

1. A method for manufacturing a resin structured insert for a mold for manufacturing a timepiece or jewelry component, wherein the method comprises:
providing a template element comprising a structured surface with a pattern to be reproduced on a surface of a timepiece component;
covering the structured surface of the template element with a molding resin capable of reproducing a negative pattern of the pattern of the structured surface, and leaving the molding resin to solidify in order to obtain a resin structured insert; and
separating the structured insert from the template element, the structured insert comprising a surface comprising the negative pattern.

2. The method for manufacturing a structured insert as claimed in claim 1, wherein the pattern to be reproduced from the template element comprises at least one raised relief, measured in the direction perpendicular to the structured surface of the template element, in a range of from 1 nm to 2 mm.

3. The method for manufacturing a structured insert as claimed in claim 1, wherein the pattern to be reproduced from the template element comprises at least one cavity in the structured surface, wherein an opening of the cavity is narrower than a largest width of the cavity, or wherein the cavity comprises a lower section parallel to the structured surface with a larger area than another parallel section placed above the lower section.

4. The method for manufacturing a structured insert as claimed in claim 1, wherein the structured surface of the template element comprises:
a natural pattern originating directly from a leather, a skin, a vegetable leaf, or microcrystals; or
an artificial pattern.

5. The method for manufacturing a structured insert as claimed in claim 1, wherein the molding resin has a viscosity before solidification at ambient temperature and pressure in a range of from 0.5 to 70,000 Pa·s⁻¹.

6. The method for manufacturing a structured insert as claimed in claim 1, wherein the molding resin comprises polyurethane, latex, acrylic resin, fluoroelastomer, epoxy resin, or two-component silicone.

7. The method for manufacturing a structured insert as claimed in claim 1, wherein the molding resin is solidified in a flat position or is solidified from a non-planar template element.

8. The method for manufacturing a structured insert as claimed in claim 1, wherein the structured insert has a maximum thickness ranging in a range of from 0.2 mm to 2 mm.

9. The method for manufacturing a structured insert as claimed in claim 1, where the solidifying of the molding resin comprises polymerizing at ambient temperature for a duration in a range of from 1 to 30 minutes.

10. The method for manufacturing a structured insert as claimed in claim 1, wherein a hardness of the structured insert is in a range of from 20 to 90 Shore A.

11. The method for manufacturing a structured insert as claimed in claim 1, wherein the method further comprises: depositing a coating of a release agent onto the structured insert.

12. A method for manufacturing a timepiece or jewelry component, comprising:
manufacturing a resin structured insert as claimed in claim 1, and
manufacturing a timepiece component, wherein the manufacturing of the timepiece component comprises:
positioning the resin structured insert in a housing of a mold for manufacturing the timepiece component;
filling the manufacturing mold including the resin structured insert with a component material, including filling the negative pattern of the resin structured insert, and then leaving the component material to solidify in order to obtain a blank of the timepiece component comprising a structured surface comprising the pattern of the template element;
removing the blank of the timepiece component from the mold;
optionally, finishing the blank.

13. The method for manufacturing a timepiece component as claimed in claim 12, wherein the removing of the blank of the timepiece component from the mold comprises:
removing the blank of the timepiece component and the structured insert secured to the blank of the timepiece component, then
optionally, finishing the blank, and
separating the timepiece component from the structured insert.

14. The method for manufacturing a timepiece component as claimed in claim 12, wherein the filling of the manufacturing mold comprises:
casting or injecting a material of the component, and
allowing t e timepiece component to be formed, wherein the timepiece component comprises an integrally formed structured surface.

15. The method for manufacturing a timepiece component as claimed in claim 12, wherein the timepiece component is flexible and has a non-planar shape at rest.

16. The method for manufacturing a timepiece component as claimed in claim 12, wherein a material of the timepiece component is based on an elastomer.

17. A timepiece component made of elastomer material, wherein the timepiece component comprises a one-piece part, comprising a structured surface that comprises at least one of the following features:
at least one relief having a height measured in the direction perpendicular to the structured surface in a range of from 1 nm to 2 mm;
a plurality of intersecting reliefs;
at least one cavity, wherein an opening of the cavity is narrower than a largest width of the cavity, or wherein the cavity comprises a lower section parallel to the structured surface with a larger area than another parallel section positioned above the lower section.

18. A timepiece component made of elastomer material as claimed in claim 17, wherein the timepiece component is curved or arched.

19. An assembly comprising a template element and the timepiece component as claimed in claim 18, wherein the timepiece component comprises a structured surface that reproduces a structured surface of the template element with a resolution that is less than or equal to 1 μm.

20. The method for manufacturing a resin structured insert as claimed in claim 1, comprising cutting the structured insert to a format corresponding to at least a portion of the timepiece component to be manufactured.
